(19) United States
(12) Patent Application Publication
(10) Pub. No.: US 2025/0057156 A1
(43) Pub. Date: Feb. 20, 2025

(54) PEST CONTROL COMPOSITION

(71) Applicant: The Procter & Gamble Company, Cincinnati, OH (US)

(72) Inventors: Michael David O'Young MUI, Mason, OH (US); Jorge Max SUNKEL, West Chester, OH (US)

(21) Appl. No.: 18/800,231

(22) Filed: Aug. 12, 2024

Related U.S. Application Data
(60) Provisional application No. 63/519,695, filed on Aug. 15, 2023.

(51) Int. Cl. A01N 31/02; A01N 25/06; A01N 25/30; A01N 27/00; A01N 35/06; A01N 37/10; A01N 65/06; A01N 65/08; A01N 65/22; A01N 65/24; A01N 65/28; A01N 65/44; A01P 13/00

(52) U.S. Cl. CPC A01N 31/02; A01N 25/06; A01N 25/30; A01N 27/00; A01N 35/06; A01N 37/10; A01N 65/06; A01N 65/08; A01N 65/22; A01N 65/24; A01N 65/28; A01N 65/44; A01P 13/00

(57) ABSTRACT

The present disclosure relates to a pest control composition and to methods for controlling pests, including plant pests and arthropod pests. More particularly, the disclosure relates to a pest control composition that is substantially clear and colorless, especially over a range of environmental conditions, yet efficacious.

### CROSS REFERENCE TO RELATED APPLICATIONS

This application claims the benefit of U.S. Provisional Application No. 63/519,695, filed Aug. 15, 2023, the entire disclosure of which is fully incorporated by reference herein.

### FIELD OF THE INVENTION

The present disclosure relates to a pest control composition and to methods for controlling pests, including plant pests and arthropod pests. More particularly, the disclosure relates to a pest control composition that is substantially clear and colorless, especially over a range of environmental conditions, yet efficacious.

### BACKGROUND OF THE INVENTION

The market for pest control products, such as weed control products and arthropod pest control products, is growing, due to factors such as an increase in urban housing, changes in weather patterns, and an increase in home food gardening and the desire to keep lawns, flower beds, etc. looking neat and attractive. At the same time, there is increasing consumer demand for products, e.g., insecticides, herbicides, that are natural. Consumers also prefer products that contain a limited number of ingredients and/or recognizable ingredients, as communicated by simpler ingredient statements. However, these products are still expected to be efficacious and efficiently control pests, such as weeds and arthropods, comparable to traditional chemical pest control or pesticide products.

There are existing pest control products that contain natural ingredients, such as plant essential oils. However, these existing products have a number of disadvantages: some products may be unstable at cold temperatures (i.e., about 5° C. to 10° C.) and/or separate into multiple phases. Separation into multiple phases may lead to inconsistent consumer use experiences and uneven efficacy, as active ingredients may aggregate in a phase that does not get dispensed without extraordinary effort by the user, e.g., vigorous mixing. Moreover, this situation may be exacerbated when the pest control composition is housed in an opaque container, because the user may be unaware that the composition is separated. Other products do not provide optimal scent experience, e.g., emit a long-lasting, unpleasant odor, and/or do not provide optimal aesthetics e.g., appear cloudy, or turbid, and/or off color. Still other products may stain or leave a residue on treatment surfaces, e.g., countertops, floors, driveways, patios, sidewalks, etc. Therefore, there is a need for an effective pest control composition that contains fewer and/or natural ingredients, is stable, even at cold temperatures, provides improved aesthetics, and/or provides an improved scent experience.

### SUMMARY OF THE INVENTION

A pest control composition comprises: (a) from about 1% to about 12.5% by weight of the pest control composition of sodium lauryl sulfate; (b) from about 0.15% to about 15% by weight of the pest control composition of an active ingredient; (c) from about 0.5% to about 10% by weight of the pest control composition of urea; and (d) from about 60% to about 95% by weight of the pest control composition of water.

A process for making a pest control composition, wherein the composition comprises sodium lauryl sulfate, an active ingredient, an optional solvent, and urea, the process comprising the steps of: (a) combining the sodium lauryl sulfate, the active ingredient, and the optional solvent, to make an active ingredient premix; (b) combining the active ingredient premix with an aqueous phase comprising water, urea, and an optional ingredient selected from a pH adjusting agent, a preservative, or a mixture thereof to form the pest control composition; where the pest control composition has a pH of about 3.0 to about 11.0.

### BRIEF DESCRIPTION OF THE DRAWINGS

FIG. 1 shows the Symptom Assessment for ratings 1, 3, and 5 of the Weed Control Efficacy Test Method, where the images on the left show an untreated control and images on the right show a treated sample.

### DETAILED DESCRIPTION OF THE INVENTION

Consumers are looking for effective and natural ways to kill and control a broad spectrum of pests, including a broad spectrum of weeds and a broad spectrum of arthropods. Also, there is increasing consumer demand for pesticide products, including insecticide products and herbicide products, that are natural, non-toxic, contain a limited number of (preferably recognizable) ingredients (having simpler ingredient statements), are stable (e.g., phase stable) across a range of environmental conditions, and/or provide improved product aesthetics and provide improved product aesthetics. A substantially clear, aqueous, single-phase pest control composition is particularly desirable, as clarity may connote purity to the consumer. And, consumers expect such pest control compositions to be consistently efficacious against pests (e.g., weeds and arthropod pests), comparable to traditional chemical pesticide products.

Currently marketed pest control products that are labeled as “natural” or containing “plant-based ingredients” have limited efficacy, are often messy to use, are unstable at cold temperatures, and/or provide an unpleasant and/or inconsistent consumer experience, such as by requiring a consumer to shake the product before use, by appearing off color, and/or by exhibiting an unpleasant odor. Described herein is a stable aqueous pest control composition comprising one or more plant essential oils and/or one or more components or constituents of plant essential oils that is efficacious against a variety of pests, including a variety of plants and arthropods. As used herein, “stable” refers to a pest control composition that is substantially clear and free from phase separation or precipitation, where no agitation or mixing is required to use the pest control composition for its application.

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, “contacting” refers to treating, applying, spraying, wetting, soaking, dousing, dipping, immersing, sprinkling, wiping, daubing, spreading, splattering, smearing, etc., any weeds, portions of weeds, etc., desired to be killed, removed, destroyed, defoliated, exterminated, eradicated, eliminated, etc., with the pest control composition described herein.

As used herein, “effective amount” refers to an amount of the pest control composition, which is effective to noticeably kill, remove, destroy, defoliate, exterminate, eradicate, eliminate, etc., pests (e.g., insects, weeds) when those pests are contacted with the pest control composition.

As used herein, the terms “include”, “includes” and “including” are meant to be non-limiting.

As used herein, the term “natural oils” means oils that are derived from plant or algae matter. Natural oils are not based on kerosene or other fossil fuels.

As used herein, “non-staining” refers to those embodiments of the pest control composition of the present disclosure which may impart minimal to no discoloration to outdoor surfaces such as slate, concrete, asphalt, pavers, stone, wood and/or metal walkways, etc., when applied in contacting, treating, etc., pests, such as weeds. In some instances, these non-staining embodiments may impart a slight non-staining residue, film, etc. which may remain after the applied pest control composition has dried and which may be easily removed after being rinsed, washed, soaked, etc., for example, with water, rain, other aqueous liquids, etc. Some embodiments of the pest control composition described herein may be non-staining.

As used herein, “pest control” means the management of a pest species, including any animal, such as insects and other arthropods, plant, or fungus that adversely impacts human activities or the environment, where management includes controlling, killing, eliminating, repelling, or attracting the pest species. Pest control products and compositions may include products and compositions for managing a pest species inside and outside of a building, such as a dwelling or a business, including, but not limited to, areas such as garages, patios, balconies, screened porches, lawns, and/or gardens. Pest control products and compositions may include products and compositions for use in and/or on yards, lawns, bushes, trees, and/or outdoor plants, as well as for use on or around indoor plants. Pest control products and compositions may include selective and non-selective products and compositions, such as selective and non-selective herbicides, fungicides, and insecticides. Pest control products and compositions may also include products and compositions for topical application to humans to control or repel pest species, such as insects and other arthropods.

The terms “pest control” and “pesticide” are used interchangeably and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest.

As used herein, “substantially free of” or “substantially free from” refers to either the complete absence of an ingredient or a minimal amount thereof merely as impurity or unintended byproduct of another ingredient. A composition that is “substantially free” of/from a component means that the composition comprises less than about 0.05%, or less than about 0.025%, or less than about 0.010%, or less than about 0.005%, or less than about 0.0025%, or less than about 0.001%, by weight of the composition of the component.

As used herein, “weed” refers to the common meaning of the term as any herbaceous plant, vegetation, foliage, grasses, etc., which is deemed to be undesirable or undesired, for example, as encumbering the ground, as hindering, stifling, overwhelming, etc., the growth of what is deemed desired or more desirable plant, vegetation, foliage, grasses, etc. Weeds for which the herbicide composition are effective against may include one or more of: broadleaf weeds such as dandelions, clover, plantain, chickweed, undesired grasses, moss, other common weeds, etc.

Volatile Organic Compounds (VOCs) are identified by the U.S. Environmental Protection Agency (EPA) as organic compounds that participate in atmospheric photochemical reactions, with the exception of compounds that have negligible photochemical reactivity. VOCs are generally emitted as gases from certain solids or liquids. EPA regulations define a chemical as “VOC-exempt” if it has vapor pressure of less than 0.1 millimeters of mercury (at 20° C.). If the vapor pressure is unknown, a chemical is defined as “VOC-exempt” if it a) consists of more than 12 carbon atoms; or b) has a melting point higher than 20° C. and does not sublime (i.e., does not change directly from a solid into a gas without melting).

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All weights, measurements and concentrations herein are measured at 25 degrees Celsius (° C.) and 50% relative humidity, unless otherwise specified.

### Pest Control Composition

The pest control composition is preferably in the form of a liquid. The pest control composition is preferably an aqueous composition.

The pest control compositions disclosed herein may comprise less than about 15 ingredients, preferably less than about 10 ingredients, more preferably less than about 15 ingredients and greater than about 5 ingredients.

The pest control compositions of the present disclosure may comprise renewable components. The compositions disclosed herein may comprise from about 1%, or from about 5%, or from about 10%, or from about 20%, or from about 30%, or from about 40%, or from about 50% to about 40%, or to about 50%, or to about 60%, or to about 70%, or to about 80%, or to about 90%, or to about 100% by weight of renewable components. The compositions disclosed herein may be at least partially or fully bio-based, As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise ingredients listed under section 25(b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (see, e.g., US law (sections 201(s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients enables the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

### Water

Aqueous liquid compositions are convenient to use because these compositions can be readily applied directly to arthropod pests or weeds, while leaving minimal residue on adjacent surfaces. The pest control compositions may be substantially free of a geologically derived (e.g., petroleum-based) carrier oils, such as mineral oil, as products containing a carrier oil may be messy to use and may leave a residue on a treated surface.

The pest control compositions may comprise from about 40% to about 99%, or from about 45% to about 98%, by weight of the composition of water. The pest control composition may comprise from about 40% to about 97%, or from about 60% to about 95%, or from about 50% to about to about 92%, or from about 70% to about 90%, or from about 55% to about 80%, or from about 78% to about 83%, or from about 58% to about 78%, or from about 60% to about 75%, or from about 62% to about 72%, by weight of the total composition of water.

### Active Ingredients

The pest control composition may comprise one or more active ingredients (also referred to herein as actives). The pest control composition may comprise from about 0.005% to about 30%, or from about 0.005% to about 15%, or from about 0.05% to about 25%, or from about 0.15% to about 20%, or from about 0.15% to about 15%, or from about 0.5% to about 12%, or from about 0.5% to about 10%, or from about 1% to about 12%, or from about 1% to about 10%, or from about 2% to about 10%, or from about 3% to about 8%, or from about 4% to about 7%, by weight of the composition of one or more active ingredients. The pest control composition may comprise a first active ingredient and a second active ingredient.

Suitable active ingredients may include plant oils/essential plant oils (including synthetic analogues) and/or constituents thereof (including synthetic analogues). The one or more active ingredients may be natural oils. Nonlimiting examples of active ingredients include aldehyde C16 (pure), almond oil, alpha-terpineol, verbenone, alpha-cedrene, cinnamic aldehyde, amyl cinnamic aldehyde, cinnamyl acetate, amyl salicylate, anisic aldehyde, cedrol, benzyl acetate, cinnamaldehyde, cinnamic alcohol, carvacrol, carveol, citral, citronellal, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), d-limonene, linalool, alpha-pinene, tetrahydrolinalool, ethyl cinnamate, eugenol, iso-eugenol, methyl iso-eugenol, galaxolide, geraniol, guaiacol, ionone, menthol (e.g., L-menthol), menthone, carvone (e.g., L-carvone), camphor, p-cymene, bornyl acetate, isobornyl acetate, gamma-terpinene, methyl anthranilate, methyl ionone, methyl salicylate, nerol, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, castor oil, cedar oil, cinnamon, cinnamon oil, citronella, citronella oil, clove, corn oil, cornmint oil, cottonseed oil, garlic, garlic oil, linseed oil, mint, mint oil, thyme, peppermint, peppermint oil, spearmint, spearmint oil, rosemary, sesame, sesame oil, soybean oil, white pepper, licorice oil, wintergreen oil, star anise oil, lilac flower oil, black seed oil, grapefruit seed oil, grapefruit, lemon oil, orange oil, tea tree oil, tagete minuta oil, lavender oil, lippia javancia oil, oil of bergamot, galbanum oil, lovage oil, and combinations thereof.

Nonlimiting examples of essential oils include thyme (thymol, carvacrol), oregano (carvacrol, terpenes), lemon (limonene, terpinene, phellandrene, pinene, citral), orange flower (linalool, β-pinene, limonene), orange (limonene, citral), anise (anethole, safrol), clove (eugenol, eugenyl acetate, caryophyllene), rose (geraniol, citronellol), rosemary (borneol, bornyl esters, camphor), geranium (geraniol, citronellol, linalool), lavender (linalyl acetate, linalool), citronella (geraniol, citronellol, citronellal, camphene), eucalyptus (eucalyptol), peppermint (menthol, menthyl esters), spearmint (carvone, limonene, pinene), wintergreen (methyl salicylate), camphor (safrole, acetaldehyde, camphor), bay (eugenol, myrcene, chavicol), cinnamon (cinnamaldehyde, cinnamyl acetate, eugenol), tea tree (terpinen-4-ol, cineole), cedar leaf (α-thujone, β-thujone, fenchone), geranium (Citronellol, Geraniol, guaiadiene), Cornmint (Menthol, Menthone), garlic (dimethyl trisulfide, diallyl disulfide, diallyl sulfide, diallyl tetrasulfide, 3-vinyl-[4H]-1,2-dithiin), and combinations thereof.

The pest control composition may comprise about 0.005% to about 15%, preferably from about 0.05% to about 15%, more preferably from about 0.15% to about 12%, even more preferably from about 0.5% to about 10% of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

The pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The pest control composition may comprise less than about 10%, or less than about 5%, or less than about 2%, or less than about 1%, or less than about 0.5%, or less than about 0.1%, by weight of a synthetic pesticide. Alternatively, the pest control composition may be substantially free of synthetic pesticide.

The pest control composition may comprise one or more biopesticides. Nonlimiting examples of biopesticides include pyrethrum, rotenone, neem oil, and mixtures thereof.

The pest control composition may comprise from about 0.05% to about 15%, or from about 0.05% to about 15%, or from about 0.15% to about 15%, or from about 0.5% to about 15%, or from about 0.5% to about 10%, by weight of the composition of one or more active ingredients, where the active ingredient is an essential plant oil and/or a constituent thereof. The pest control composition may comprise an active ingredient selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, corn mint oil, peppermint oil, spearmint oil, rosemary oil, thyme oil, lemongrass oil, citronella oil, and mixtures thereof, more preferably selected from the group consisting of geraniol, corn mint oil, peppermint oil, rosemary oil, and combinations thereof.

The pest control composition may comprise or from about 0.15% to about 10%, preferably from about 0.50% to about 10%, by weight of the composition of an active ingredient selected from the group consisting of citronella oil, spearmint oil, cornmint oil, peppermint oil, and combinations thereof, preferably selected from the group consisting of corn mint oil, peppermint oil, and combinations thereof. In some aspects, the pest control composition may comprise from about 0.005% to about 10% by weight of the pest control composition, alternatively from about 0.50 to about 10%, alternatively from about 1% to about 10%, alternatively from about 1% to about 8%, of one or more an active ingredients selected from the group consisting of menthol, menthone, citronellol, citronellal, geraniol, limonene, carvone, pinene, and combinations thereof, preferably selected from the group consisting of menthol, menthone, geraniol, and combinations thereof.

The pest control composition may comprise a first active ingredient and a second active ingredient. Without being bound by theory, it is believed that pesticidal efficacy, such as weed control efficacy, may be improved by combining several active ingredients. The weight ratio of second active ingredient to first active ingredient, preferably geraniol, may be about 1:12 to about 6:1, or from about 1:10 to about 5.5:1, or from about 1:8 to about 5:1, or from about 1:5 to about 4:1, or from about 1:3 to about 3:1.

### Surfactant

The pest control composition may be formulated with one or more surfactants. The pest control composition may comprise from about 0.01% to about 15%, or from about 0.1% to about 12.5%, or from about 0.1% to about 11%, or from about 0.5% to about 10%, or from about 1% to about 9%, or from about 1% to about 15%, or from about 2% to about 12.5%, or from about 4% to about 8%, by weight of the pest control composition of one or more surfactants, preferably one or more anionic surfactants, more preferably sodium lauryl sulfate.

A sprayed drop of a pest control composition is preferably able to wet a target surface and spread out or cover a target area to perform its intended function. A surfactant generally reduces the surface tension of the water on the surface of the spray drop by reducing the interfacial tension between the spray drop and target surface, e.g., the surface of the weed. Surfactants also wet and disperse particles of active ingredient(s) in the composition prior to spraying, thereby enabling more uniform coverage and wetting of the target weed upon spraying. Surfactants may also function to emulsify hydrophobic active agents that are not easily solubilized in water, such as oils. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (e.g., sodium dodecyl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO.

A preferred anionic surfactant is sodium lauryl sulfate or “SLS” (also known as sodium dodecyl sulfate). The pest control composition may comprise from about 1% to about 12.5%, or from about 1% to about 10%, or from about 2% to about 8.5%, or from about 3% to about 9%, or from about 4% to about 8%, by weight of the pest control composition of sodium lauryl sulfate. The pest control composition may comprise from about 4% to about 8% by weight of the composition of sodium lauryl sulfate and the weight ratio of the second active ingredient to the first active ingredient, preferably geraniol, may be about 1:12 to about 1:1, or about 1:8 to about 1:1, or about 1:4 to about 1:1. The pest control composition may comprise from about 6% to about 10% by weight of the composition of sodium lauryl sulfate and the weight ratio of the second active ingredient to the first active ingredient, preferably geraniol, may be about 1:2 to about 6:1.

Anionic surfactants also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts of fatty acids are also known as soaps and the counter ions of the salts may be sodium, potassium, calcium, magnesium, barium, iron, ammonium and amine salts of fatty acids. Fatty acid and the salts thereof may be linear, branched, saturated, unsaturated, cyclic, or mixtures thereof. Nonlimiting examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

The pest control composition may comprise one or more active ingredients, such as one or more hydrophobic active ingredients (such as a natural oil or a constituent thereof), and surfactant, preferably anionic surfactant, more preferably sodium lauryl sulfate. The weight ratio of surfactant to total active ingredient may be from about 1:3 to about 30:1, or about 1:3 to about 20:1, or about 1:1 to about 30:1, or about 1:1 to about 20:1, or about 1:1 to about 10:1, or about 1:1 to about 5:1, or about 1:3 to about 3:1, or about 1:2 to about 2:1, or about 1:1.5 to about 1.5:1, or about 1:1.2 to about 1.2:1. It has been surprisingly found that if the ratio of total (hydrophobic) active ingredient to sodium lauryl sulfate is too high, there may not be enough sodium lauryl sulfate to emulsify the (hydrophobic) active ingredient, particularly over a range of temperatures from about 5° C. to about 40° C. temperatures. If the hydrophobic active ingredient is not sufficiently emulsified, then a layer of the hydrophobic ingredient, e.g., oil, may form on top of the composition, causing the composition to appear turbid. However, if the ratio of hydrophobic active ingredient to sodium lauryl sulfate is too low, then there may be too much free sodium lauryl sulfate, which may precipitate at cold temperatures.

The pest control composition may comprise geraniol, a second active ingredient, such as corn mint oil and/or peppermint oil, and sodium lauryl sulfate, where the weight ratio of sodium lauryl sulfate to total active ingredient may be about 1:1 to about 5:1. The pest control composition may comprise geraniol, a second active ingredient, such as spearmint oil, and sodium lauryl sulfate, where the weight ratio of sodium lauryl sulfate to total active ingredient may be less than or equal to about 4:3. The pest control composition may comprise geraniol, a second active ingredient, such as citronella oil, and sodium lauryl sulfate, where the weight ratio of sodium lauryl sulfate to total active ingredient may be less than or equal to about 2:1.

The pest control composition may comprise an amphoteric surfactant, a zwitterionic surfactant, a nonionic surfactant, or a mixture thereof (in addition to or instead of an anionic surfactant). Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alkyl sultaines, and alkylamidoalkylenehydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280.

The pest control composition may optionally comprise one or more cationic surfactants. Suitable cationic surfactants include quaternary ammonium surfactants and amino surfactants that are positively charged at the pH of the pest control composition.

### Urea

The pest control composition may comprise from about 0.1% to about 10%, or from about 0.5% to about 10%, or from about 0.5% to about 8%, or from about 1% to about 6%, by weight of the composition of urea. Without wishing to be bound by theory, urea may improve the stability, availability, and/or solubility of the one or more active ingredients in the composition, thereby improving the efficacy of the composition without increasing the concentration of VOCs. Further, urea may improve the low temperature stability of compositions containing anionic surfactants, such as SLS.

### Solvent

The pest control compositions described herein may comprise from about 0.01% to about 50%, or from about 0.05% to about 45%, or from about 0.1% to about 45%, or from about 0.1% to about 40%, or from about 0.1% to about 35%, or from about 0.5% by weight to about 30% by weight, or from about 1% to about 25%, or from about 1% to about 15%, or from about 1% by weight to about 10%, or from about 1% by weight to about 5%, or from about 1.5% to about 3%, by weight of the composition of solvent. Liquid pest control compositions may contain one or more solvents and water.

Suitable solvents include alcohols, such as monohydridic or polyhydridic alcohols. Preferred monohydridic alcohols are low molecular weight primary or secondary alcohols exemplified by ethanol, propanol, and isopropanol, preferably isopropanol. Polyhydridic alcohols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents also include esters. The pest control composition may comprise from about 0.005% to about 15%, or from about 0.05% to about 12%, or from about 0.5% to about 10%, or from about 1% to about 7% by weight of the composition of one or more esters. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The pest control composition may comprise triethyl citrate, preferably from about 0.005% to about 15%, or from about 0.05% to about 12%, or from about 0.5% to about 10%, or from about 1% to about 7%, by weight of the composition of triethyl citrate.

Additional solvents include lipophilic fluids, including siloxanes, other silicones, hydrocarbons, glycol ethers, glycerin derivatives such as glycerin ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), isopropyl alcohol, and glycerin.

Preferred solvents include isopropanol, triethyl citrate, ethanol, glycerin, ethyl lactate, renewable versions thereof, and mixtures thereof. The pest control compositions described herein may comprise a solvent selected from the group consisting of isopropanol, triethyl citrate, and mixtures thereof. In some aspects, the pest control composition may comprise less than about 2.5% glycerin, by weight of the pest control composition. In some aspects, the pest control composition is substantially free of glycerin.

### pH Adjusting Agents

The pest control composition may comprise a buffer system. The buffer system may comprise one or more pH adjusting agents, such as an acid. The buffer system may comprise an acid (such as citric acid and/or acetic acid) and its conjugate base (such as a salt of citric acid and/or acetic acid). When the pest control composition comprises a buffer system, the acid may be citric acid or acetic acid and the conjugate base may be a sodium salt of the respective acid.

The pest control compositions may comprise from about 0.00001% to about 5%, or from 0.01% to about 5%, or from about 0.1% to about 4%, or from about 1% to about 3.5%, by weight of the composition of a pH adjusting agent, such as a carboxylic acid or a salt thereof, e.g., citric acid or a salt thereof. Alternatively, the pest control compositions may comprise from about 0.00001% to about 1.5%, or from about 0.0001% to about 1%, or from about 0.001% to about 0.8%, or from about 0.01% to about 0.6%, by weight of the composition of a pH adjusting agent, such as a carboxylic acid or a salt thereof, e.g., citric acid or a salt thereof. Non-limiting examples of pH adjusting agents may include malic acid, citric acid, fumaric acid, humic acid, acetic acid, monosodium citrate, sodium citrate, disodium citrate, trisodium citrate, trisodium citrate dehydrate, trisodium citrate pentahydrate, sodium acetate, or combinations thereof. The pH adjusting agent may be selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. Preferably, the pH adjusting agent is selected from the group consisting of sodium citrate, citric acid, sodium acetate, acetic acid, and combinations thereof. Carboxylic acids, such as citric acid, or salts thereof may also function as chelants.

### Preservatives

The pest control composition may comprise one or more preservatives. As used herein a “preservative” is any substance or compound that is added to protect against decay, decomposition, or spoilage. Preservatives may be natural or synthetic. Preservatives may be antimicrobial preservatives, which inhibit the growth of bacteria or fungi, including mold, or antioxidants. Nonlimiting examples of preservatives include potassium sorbate, sodium benzoate, tocopherol (e.g., tocopherol acetate), calcium propionate, sodium nitrate, sodium nitrite, sulfites (sulfur dioxide, sodium bisulfite, potassium hydrogen sulfite, etc.), tetrasodium EDTA, and disodium EDTA. The pest control composition may comprise from about 0.02% to about 4%, by weight of the pest control composition of a preservative, alternatively from about 0.1% to about 2%, alternatively from about 0.2% to about 1%, alternatively from about 0.3% to about 0.5%, preferably a preservative selected from the group consisting of potassium sorbate, sodium benzoate, tocopherol, and mixtures thereof. In some aspects, the pest control composition may be substantially free of a preservative.

The pest control compositions may have a surface tension ranging from about 10 mN/m to about 60 mN/m, or from about 15 mN/m to about 50 mN/m, or from about 18 mN/m to about 40 mN/m, or from about 20 mN/m to about 30 mN/m, or from about 22 mN/m to about 28 mN/m, as measured according to the method described herein. It is believed that droplets may be preferred for delivering a targeted spray (particularly for non-selective herbicide compositions), while also sufficiently covering a target area.

The pest control compositions may comprise particles having an intensity mean particle size of from about 2 nm to about 500 nm, alternatively from about 4 nm to about 400 nm, alternatively from about 5 nm to about 100 nm. The composition may comprise particles having an intensity mean particle size of less than about 1 micron, preferably less than about 500 nm. Mean intensity particle size can be measured according to the Particle Size Test Method described hereafter.

The pest control composition may comprise particles having a volume mean particle size ranging from about 1 nm to about 100 nm, or from about 2 nm to about 50 nm, or from about 2 nm to about 25 nm, or from about 2 nm to about 10 nm. The composition may comprise particles having a volume mean particle size of less than about 1 micron, preferably less than about 500 nm. Mean volume particle size can be measured according to the Particle Size Test Method described hereafter. Volume mean particle size may be selected to provide a transparent or translucent composition, as well as to efficiently deliver an active agent to the target surface or area.

The pest control compositions may be subject to fluctuating temperatures during shipping, storage, and/or use. The pest control composition may be stable (clear and a single phase) at low temperatures (i.e., from about 5° C. to about 10° C.). The pest control composition may be stable (clear and a single phase) at 25° C., as clarity may connote purity to the user. In some respects, the pest control composition is also clear and a single phase at 5° C. and maintains clarity and a single phase when warmed to 25° C. Maintaining clarity and phase stability over a range of temperatures below 25° C. may be important for pesticides because they are often stored in areas devoid of temperature control (e.g., garage, shed).

The pest control composition may have a relatively high level of clarity (i.e., low turbidity). Some consumers prefer a clear product versus a product that is cloudy or murky (i.e., higher turbidity). A clear, transparent, or translucent composition that is a single phase may connote purity, quality, and/or that the composition is not likely to stain surfaces. The composition may exhibit a turbidity of less than about 200 NTU, or less than about 100 NTU, or from about 0.5 NTU to about 50 NTU, or from about 1 NTU to about 25 NTU. The pest control composition may exhibit a turbidity of less than about 20 NTU, or less than about 15 NTU, or less than about 10 NTU, or less than about 8 NTU. The pest control composition may exhibit a turbidity of from about 1.5 NTU to about 20 NTU, or from about 1.5 NTU to about 15 NTU, or from about 1.5 NTU to about 10 NTU, or from about 1.5 NTU to about 8 NTU. Turbidity of the compositions is measured with a laboratory turbidity meter as described in the Turbidity Method below.

The pest control composition may have a reduced yellow color or may be substantially colorless. Some consumers prefer a colorless or substantially colorless product versus a product that has a yellow color. Yellow color may be characteristic of the breakdown of certain active ingredients in the compositions, particularly the breakdown of plant oils, such as cornmint oil. The reduction of the yellow color may be measured by any colorimetric or spectrometric method known in the art.

The CIELAB color scale (according to ASTM D5386-93b may be used to quantify the color of an arthropod pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. The composition may have a b* value from about 0 to about 5, or from about 0 to about 4, or from about 0 to about 3, or from about 0.01 to about 4, or from about 0.05 to about 3.5, or from about 0.1 to about 3. The pest control composition may have a b* value of from about 0.4 to about 5, or from about 0.4 to about 4, or from about 0.4 to about 3. A composition with a b* value according to the disclosed ranges may be perceived by a consumer as having a colorless appearance, while b* values outside the disclosed ranges, especially b* values greater than 5, may appear yellow to a consumer, which may connote that the composition contains impurities, has degraded, and/or is unsuitable for use. The pest control composition may be substantially free of a dye or colorant.

The pest control compositions may have a Brookfield viscosity ranging from about 1 cps to about 500 cps, or from about 1 cps to about 300 cps, or from about 1 cps to about 200 cps, or from about 1 cps to about 100 cps, or from about 2 cps to about 100 cps, or from about 3 cps to about 50 cps, as measured according to the method described herein. The Brookfield viscosity may enable the aerosol dispensing device to dispense the composition as droplets. For some products, such as pesticide products, droplets may be preferred, particularly versus a mist, a stream, or a foam.

The pest control composition may be provided in the form of a concentrated composition, which is mixed with a diluent, e.g., water, prior to use, or a ready-to-use composition, which can be directly applied (e.g., as a spray) to pests, such as arthropods and weeds, and need not be diluted by a consumer before use. Ready-to-use compositions may be preferred by some consumers, because ready-to-use compositions do not require dilution by the consumer, which may be messy, inconvenient, and/or require multiple containers. The pest control composition may contain select ingredients at select levels suitable to be sprayed directly onto pests.

The pest control composition may have a pH ranging from about 3.0 to about 11.0, or from about 4.0 to about 11.0, or from about 4.0 to about 9.0, or from about 5.0 to about 9.0, or from about 5.0 to about 8.0, or from about 6.0 to about 8.0, or from about 6.0 to about 7.0.

The pest control compositions may be “low VOC” compositions and comprise about 3% volatile organic compounds (VOCs) by weight or less. Alternatively, the pest control composition may comprise greater than 3% volatile organic compounds (VOCs) by weight. The pest control composition may comprise greater than 3% to about 35% by weight of volatile organic compound (VOC). It may be desirable to keep the total level of VOCs in the pest control composition to less than or equal to about 3% by weight. VOCs can be measured according to the California Air Resources Board (CARB) Method 310 for VOC determination (May 25, 2018).

VOCs may come from one or more ingredients in the composition, including the solvent and/or essential oil. It was found that by changing the level of solvent, particularly isopropyl alcohol, the total level of VOCs in the pest control composition could be maintained at a level of less than or equal to about 35%, or less than or equal to about 20%, or less than or equal to about 10%, or less than or equal to about 3%, while still maintaining a substantially clear and colorless pest control composition. The pest control composition may comprise from about 0.01% to about 3%, or from about 0.1% to about 2.5%, or from about 0.5% to about 2.25%, or from about 1% to about 2%, by weight of the pest control composition of isopropyl alcohol. The levels of isopropanol and/or essential oil in the pest control composition may be selected such that the total VOC level of the pest control composition is from about 0 to about 3% by weight.

The pest control composition may be a micellar dispersion or an oil-in-water emulsion. The pest control composition may be stored outside or in a garage where it may be subject to fluctuating temperatures, such as daytime and nighttime temperature changes and/or seasonal temperature changes. The pest control composition described herein may be stable at low temperatures (i.e., from about 5° C. to about 10° C.). The pest control composition has a b* value from about 0 to about 5 and/or a turbidity of less than about 20 NTU, preferably even after repeated exposure to low temperatures and/or after recovery to room temperature from cold temperature exposure.

The pest control composition may comprise: (a) from about 0.5% to about 12%, preferably about 1% to about 10%, more preferably about 2% to about 8.5%, even more preferably about 3% to about 7.5%, by weight of the composition of sodium lauryl sulfate; (b) from about 0.5% to about 15%, preferably about 1% to about 10%, more preferably about 1.5% to about 8%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, rosemary oil, lemongrass oil, and mixtures thereof; (c) from about 0.5% to about 10%, preferably from about 1% to about 5%, by weight of the composition of urea; and (d) from about 60% to about 90%, preferably about 65% to about 85%, more preferably about 70% to about 80%, by weight of the composition of water.

The pest control composition may optionally further comprise from about 0.1% to about 45%, preferably from about 0.5% to about 35%, more preferably from about 1% to about 25%, even more preferably from about 2% to about 15%, by weight of the composition of by weight of the composition of a solvent selected from the group consisting of isopropyl alcohol, triethyl citrate, isopropyl myristate, ethyl lactate, butyl lactate, butyl stearate, glycerin, and mixtures thereof, preferably selected from the group consisting of isopropyl alcohol, triethyl citrate, and mixtures thereof. The pest control composition may also optionally further comprise a carboxylic acid or salt thereof selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof. The pest control composition may also optionally further comprise an ingredient selected from pH adjusting agents, propellants, preservatives, thickeners, fatty acids or salts thereof, and combinations thereof. The pest control composition may comprise about 3% volatile organic compounds (VOCs) by weight or less.

Aqueous pest control compositions are described in U.S. application Ser. No. 17/865,943, U.S. application Ser. No. 18/082,891, U.S. application Ser. No. 18/334,004, and U.S. Provisional App. Ser. Nos. 63/509,339 and 63/509,380, all of which are hereby incorporated by reference herein. Suitable herbicide compositions may also comprise from about 40% to about 99% by weight of the composition of water and are described in WO App. Ser. No. PCT/US23/68554 and U.S. Provisional App. Ser. No. 63/355,134, which are hereby incorporated by reference herein.

### Packaging and Dispensing

The pest control compositions described herein may be packaged in any suitable container, including those constructed from paper, cardboard, plastic materials, metal, and any suitable laminates. The container may store from about 50 g to about 5,000 g, or from about 2,000 g to about 5,000 g, or from about 3,000 g to about 5,000 g, or from about 50 g to about 2,000 g, or from about 50 g to about 500 g, or from about 150 g to about 400 g, or from about 200 g to about 350 g, of the composition. The container may store from about 400 g to about 8,000 g, or from about 500 g to about 6,000 g, or from about 1,000 g to about 5,000 g, or from about 1,500 g to about 4,000 g. The weight of the pest control product, including the composition, may be selected to enable a user to comfortably manipulate and actuate the product with one hand, while providing enough composition to treat one or multiple target areas/surfaces of varying sizes, once or multiple times, e.g., multi-use product (e.g., a multi-use product).

The pest control compositions may be dispensed in any number of suitable manners, such as spraying, pouring, and the like. The pest control compositions may be dispensed by spraying using any number of known spray dispensers, e.g., pump-spray, trigger-spray, aerosol-spray, and the like. The spray dispenser may be attached to a plastic or metal container and may include known components, such as a dip tube, a valve, an actuator, and/or a nozzle for dispensing the composition to the environment. The valve may control flow and/or to seal the composition, such as within a pressurized plastic or metal container. The spray dispenser (e.g., powered spray wand, manual trigger spray) may be connected to the container by a tube or a hose, thereby allowing a user to hold the container in one hand and the spray dispenser in the other hand.

In the case of a pressurized container, in addition to the pest control composition, the container may comprise a propellant. Examples of suitable propellants include compressed gasses, such as nitrogen, carbon dioxide, and air; liquidized hydrocarbons, such as butane, isobutate, and propane; hydrofluoro-olefins, and mixtures thereof. The propellant may be selected from the group consisting of nitrogen, carbon dioxide, and mixtures thereof. The pressurized container may have an internal gage pressure of from about 414 kPa to about 1,100 kPa, or from about 600 kPa to about 1,000 kPa, or from about 700 kPa to about 900 kPa.

As detailed below, in the Spray Droplet Size Test Method, spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK). The pest control compositions, when dispensed through spray dispensers, may have a Spray D(90) ranging from about 100 microns to 900 microns, or from about 125 microns to about 800 microns, or from about 150 microns to about 700 microns. Spray D(90) may be selected to efficiently deliver an active agent to the target surface or area. Also, a Spray D(90) in the disclosed ranges may be perceived as capable of traveling a distance of one or more meters and depositing on a target surface. Particles having a Spray D(90) less than 100 microns may create a spray that is too misty or a spray that does not have sufficient velocity to travel to a target surface.

The spray dispenser may have a spray rate ranging from about 0.5 g/s to about 5 g/s, or from about 0.75 g/s to about 4 g/s, or from about 1.25 g/s to about 3.5 g/s, or from about 1.5 g/s to about 3 g/s. The spray rate may be selected to enable targeted dispensing and delivery of the composition, without over-spraying or spraying composition outside the target area.

Without being bound by theory, it is believed that the pest control products disclosed herein are particularly advantageous for the targeted spraying of pest control compositions (e.g., insecticide or herbicide) from a distance of about 0.3 m to about 1.5 m, preferably about 0.3 m to about 1 m, from the target pest or surface. The composition (including characteristics such as viscosity and surface tension), the dispensing pressure, and/or the nozzle design may be selected to provide optimal spray exit velocity and particle size distribution (PSD) for spraying a pest control product on the target pest or surface at a distance of about 0.3 m to about 1.5 m, preferably about 0.3 m to about 1 m, from the target pest or surface.

The pest control composition may be packaged in a container or bottle that is at least partially transparent or translucent. In some aspects, the container may comprise a transparent portion, such as a window. The transparent or translucent container may have a light transmittance of greater than 25% at wavelength of about 410-800 nm. Container materials that may be used include but are not limited to: polypropylene (PP), polyethylene (PE), polycarbonate (PC), polyamides (PA) and/or polyethylene terephthalate (PET), polyvinylchloride (PVC), and polystyrene (PS).

A transparent or translucent container or a transparent portion of a container may have a light transmittance of greater than 25% at wavelength of about 410-800 nm. A transparent or translucent container may have a light transmittance of more than about 25%, or more than about 30%, or more than about 40%, or more than about 50%, or more than about 60%, or more than about 80%, or more than about 95%, in the visible part of the spectrum (approx. 410-800 nm). Alternatively, absorbency of the container/bottle may be measured as less than about 0.6 or by having transmittance greater than about 25%, where % transmittance equals:

$$\frac{1}{{10}^{absorbancy}} \times 100 \%$$

For purposes of the disclosure, as long as one wavelength in the visible light range has greater than about 25% transmittance, it is considered to be transparent/translucent.

A transparent or translucent container may be desirable for housing a clear, colorless, and/or single phase pesticidal composition, as such a container allows a user to view the contents of the container, which may enable the user to confirm the suitability/useableness of the composition. For example, a user may readily observe the clear, colorless, and/or a single-phase character of the composition at the time of purchase, as well as at a later time point, such as after seasonal (e.g., winter) storage, to confirm the suitability/useableness of the composition. And, if the user observes that the composition is no longer clear or has separated into multiple phases, the user may take steps to restore the clear or single-phase character of the composition, e.g., by shaking, mixing, and/or changing the ambient temperature of the composition.

### Method for Making a Pest Control Composition

The process for making a pest control composition may comprise the steps of: a. combining sodium lauryl sulfate, an active ingredient, and an optional solvent, to make an active ingredient premix; b. combining the active ingredient premix with an aqueous phase comprising water, urea, and an optional ingredient selected from a pH adjusting agent, a preservative, or a mixture thereof to form the pest control composition; where the pest control composition has a pH of about 3.0 to about 11.0. The active ingredient may comprise geraniol and an additional ingredient selected from corn mint oil, peppermint oil, spearmint oil, rosemary oil, thyme oil, citronella oil, clove oil, cinnamon oil, cedarwood oil, garlic oil, geranium oil, lemongrass oil, eugenol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of peppermint oil, spearmint oil, corn mint oil, citronella oil, menthol, menthone, carvone, and mixtures thereof.

### Methods for Controlling Weeds

The present disclosure also relates to methods for controlling undesired weeds. In some aspects, the method for controlling weeds can comprise the steps of: (a) providing a pest control composition (e.g., an herbicide composition); and (b) contacting the weeds with an effective amount of the pest control composition. The pest control composition may be applied (e.g., by spraying as an aqueous liquid) onto a target area in an amount in the range of from about 0.5 to about 40 ml/ft, alternatively from about 0.9 to about 36 ml/ft.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. The pest control composition, e.g., herbicide, may be sprayed onto the leaves of target weeds. The pest control composition, e.g., herbicide, may be used to treat existing weeds or may be used prevent weed growth. In the latter case, the pest control composition, e.g., herbicide, may be used as a pre-emergent pest control.

The pest control composition, e.g., herbicide, may be used to control weeds that grow from a variety of surfaces. For example, the pest control composition, e.g., herbicide, may be sprayed on hard surfaces with openings containing dirt where weeds may be present or may develop, such as asphalt, concrete, interlocking bricks, roads, and highways. The pest control composition, e.g., herbicide, may be applied to lawns, golf course greens, or flower beds, where weeds may be present or may develop.

The pest control composition, e.g., herbicide, may be applied as a single treatment or as multiple treatments, such as application on consecutive days or weeks.

### Method of Controlling an Arthropod Pest

The present invention also relates to methods for controlling undesired arthropods, such as insects. In some aspects, the method of controlling an arthropod pest may comprise the steps of: (i) providing a pest control composition (e.g., an insecticide composition); (ii) contacting the arthropod pest with the pest control composition(s) as described herein; (iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### EXAMPLES

The following data and examples are provided to help illustrate the pest control compositions described herein. The exemplified compositions are given solely for the purpose of illustration and are not to be construed as limitations of the present invention, as many variations thereof are possible without departing from the spirit and scope of the invention. All parts, percentages, and ratios herein are by weight unless otherwise specified.

The sample formulations are prepared according to the method described above. Sodium lauryl sulfate, the specified active ingredient (e.g., corn mint oil, geraniol), and the specified solvent (e.g., triethyl citrate, isopropyl alcohol) are mixed in a first container to make an active ingredient premix. The sodium lauryl sulfate may be neutralized prior to mixing with the active ingredient and solvent. For example, the sodium lauryl sulfate may be neutralized with a carboxylic acid, such as citric acid. Water, urea, and an optional pH adjusting agent (e.g., a salt of citric acid, such as sodium citrate) are mixed in an appropriate second container, until the urea and optional pH adjusting agent are completely dissolved, to form an aqueous phase. The active ingredient premix is then transferred to the second container and mixed with the aqueous phase to form the sample formulation. Additional citric acid may also be added to the sample formulation as needed until a pH of from about 6.0 to about 7.0 is reached.

In view of the results in Tables 1-5, it is found that as the concentration of urea increases, temperature stability improves. The results in Tables 1-5 suggest that, as the concentration of geraniol decreases, temperature stability improves. The results in Tables 1-5 also suggest that, as the concentration of corn mint oil increases, temperature stability improves.

All in all, it is believed that increasing the concentration of geraniol may improve pesticidal efficacy, but may adversely affect temperature stability. It is further believed that, at a given concentration of geraniol, if the concentration of urea and/or corn mint oil is not high enough, particularly at cold temperatures, SLS may precipitate out of solution and/or the formula may form a solid. SLS precipitation and/or formation of a solid at cold temperatures may be particularly undesirable for sprayable pest control compositions that are stored outdoors or in unheated garages, because SLS precipitation and/or formation of a solid may clog or irreversibly damage the spray mechanism, thereby inhibiting proper dispensing of the composition. Increasing the concentration of corn mint oil may also improve pesticidal efficacy and contribute to a desirable scent profile.

### Example 1—Weed Control Efficacy

Weed control efficacy of formulations A, B, and C are measured according to the Weed Control Efficacy Test Method described hereafter. Formulations A and B are made according to the procedure described above. Formulation C is made by dissolving urea in water, at a concentration of 5% by weight urea. The results in Table 1 show that an aqueous composition containing urea alone is not efficacious for controlling weeds.

TABLE 1

| Ingredient | | | |
|---|---|---|---|
| (Weight percent) | A | B | C |
| Sodium Lauryl Sulfate | 6.50 | 6.50 | 0 |
| Citric Acid | adjust to pH 6-7 | adjust to pH 6-7 | 0 |
| Isopropyl Alcohol | 2.70 | 2.70 | 0 |
| Geraniol | 4.85 | 4.85 | 0 |
| Cornmint Oil | 1.00 | 1.00 | 0 |
| Triethyl citrate | 6.50 | 6.50 | 0 |
| Sodium Citrate | 0.25 | 0.25 | 0 |
| Urea | 5.00 | 0 | 5.00 |
| Water | QS | QS | QS |
| Weed Control Efficacy | 1 hr/3 hr/24 hr | 1 hr/3 hr/24 hr | 1 hr/3 hr/24 hr |
| (discoloration + leaf | | | |
| wilt + stem wilt) | 6/10/14 | 4/8/14 | 0/0/0 |
| (0-15 Rating Scale) | | | |
| Discoloration | 1/3/4 | 1/3/5 | 0/0/0 |
| Leaf Wilt | 3/4/5 | 2/3/5 | 0/0/0 |
| Stem Wilt | 2/3/5 | 1/2/4 | 0/0/0 |

### Example 2—Formulations C-J

TABLE 2

| Ingredient | | | | | | | | |
|---|---|---|---|---|---|---|---|---|
| (Weight percent) | C | D | E | F | G | H | I | J |
| Sodium Lauryl | 6.50 | 6.50 | 6.50 | 6.50 | 6.50 | 6.50 | 6.50 | 6.50 |
| Sulfate | | | | | | | | |
| Citric Acid | adjust | adjust | adjust | adjust | adjust | adjust | adjust | adjust |
| | to pH | to pH | to pH | to pH | to pH | to pH | to pH | to pH |
| | 6-7 | 6-7 | 6-7 | 6-7 | 6-7 | 6-7 | 6-7 | 6-7 |
| Isopropyl | 2.70 | 2.85 | 2.70 | 2.50 | 1.50 | 1.80 | 1.65 | 1.50 |
| Alcohol | | | | | | | | |
| Geraniol⁸ | 4.85 | 2.85 | 3.85 | 3.35 | 4.35 | 2.35 | 1.85 | 1.35 |
| 2^{nd} active | 1.00 | 1.00 | 0.50 | 1.00 | 1.00 | 1.00 | 1.00 | 0 |
| ingredient - | | | | | | | | |
| Corn Mint Oil¹ | | | | | | | | |
| 2^{nd} active | 0 | 1.50 | 0.50 | 0 | 0 | 0.50 | 1.00 | 0.50 |
| ingredient - | | | | | | | | |
| Peppermint | | | | | | | | |
| Organic Oil² | | | | | | | | |
| 2^{nd} active | 0 | 0 | 0 | 0 | 0 | 0.50 | 1.00 | 0.50 |
| ingredient - | | | | | | | | |
| Peppermint | | | | | | | | |
| Yakima | | | | | | | | |
| Redistilled³ | | | | | | | | |
| 2^{nd} active | 0 | 0 | 0 | 0 | 0 | 0 | 0.50 | 1.50 |
| ingredient - | | | | | | | | |
| Peppermint | | | | | | | | |
| Indian Oil⁴ | | | | | | | | |
| 2^{nd} active | 0 | 0 | 0 | 0.50 | 0.50 | 0.50 | 0.50 | 1.00 |
| ingredient - | | | | | | | | |
| Spearmint | | | | | | | | |
| Chinese Oil⁵ | | | | | | | | |
| 2^{nd} active | 0 | 0.50 | 1.00 | 1.00 | 0 | 1.00 | 0 | 1.00 |
| ingredient - | | | | | | | | |
| Citronella | | | | | | | | |
| Java Oil⁶ | | | | | | | | |
| 2^{nd} active | 1.0:4.9 | 1.1:1.0 | 1.0:1.9 | 1.0:1.3 | 1.0:2.9 | 1.5:1.0 | 2.2:1.0 | 3.3:1.0 |
| ingredient: | | | | | | | | |
| Geraniol | | | | | | | | |
| (weight ratio) | | | | | | | | |
| Triethyl citrate | 6.50 | 6.00 | 6.50 | 6.50 | 6.50 | 6.00 | 6.00 | 6.00 |
| Sodium Citrate | 0.250 | 0.250 | 0.250 | 0.250 | 0.250 | 0.250 | 0.250 | 0.250 |
| Water | QS | QS | QS | QS | QS | QS | QS | QS |
| Urea | 5 | 4 | 3 | 2 | 1 | 2 | 1 | 5 |
| Total Active | 5.85 | 5.85 | 5.85 | 5.85 | 5.85 | 5.85 | 5.85 | 5.85 |

¹Available from Lebermuth (South Bend, IN).
²Available from Lebermuth (South Bend, IN).
³Available from Lebermuth (South Bend, IN).
⁴Available from Lebermuth (South Bend, IN).
⁵Available from Lebermuth (South Bend, IN).
⁶Available from Lebermuth (South Bend, IN).
⁷ Available from Lebermuth (South Bend, IN).
⁸Available from Symrise Inc. (Elyria, OH).

### Test Methods

### Brookfield Viscosity

Brookfield viscosity is measured at 23° C.±2° C. using a Brookfield DV-E viscometer. The liquid is contained in a glass jar, where the width of the glass jar is from about 5.5 to 6.5 cm and the height of the glass jar is from about 9 to about 11 cm using spindle LV2 at 60 RPM. The test is conducted in accordance with the instrument's instructions.

### pH Test Method

pH is measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:

1) Under the ‘Measure’ section, the ‘Manual’ option is selected. ‘Measurement Type’ is then set to ‘Size’.

2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C.; ‘Viscosity’ is set at 0.8872 cP; and ‘RI’ is set as 1.330. In the ‘General options’ subsection ‘Mark-Houwink Parameters’ is selected, ‘A Parameter’ is set to 0.428; and ‘K Parameter (cm2/s)’ is set to 7.67e-05. In the ‘Temperature’ subsection: ‘Temperature’ is set as 25.0 deg C.; ‘Equilibration Time (second)’ is set to 120. In the ‘Cell’ subsection: ‘Cell Type’ is selected to be ‘Disposable cuvettes’; and the ‘DTS0012’ option is selected.

3) The ‘Measurement’ section is then selected. The ‘Angle of Detection Measurement Angle’ is selected as ‘173o Backscatter (NIBS default)’; ‘Measurement Duration’ is selected as ‘Automatic’; ‘Number of Runs’ is set to 11; ‘Run duration (seconds)’ is set to 10; ‘Number of Measurements’ is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.

4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal—analysis, Resolution’ is selected to ‘Normal’; ‘Size classes, Number of size classes’ is set as 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### Spray Droplet Size Test Method

The term “Dv10 value” describes the average particle size where 10 vol. % of the particles have a smaller size. Similarly, the term “Dv50 value” describes the average particle size where 50 vol. % of the particles have a smaller size, and the term “Dv90 value” describes the average particle size where 90 vol. % of the particles have a smaller size. The Sauter mean diameter (D[3, 2]) is the weighted average surface diameter, assuming spherical particles of the same surface area as the actual particles:

$$D [ 3 , 2 ] = \frac{\begin{matrix}\sum {D}_{i}^{3} & {n}_{i}\end{matrix}}{\begin{matrix}\sum {D}_{i}^{2} & {n}_{i}\end{matrix}} .$$

Spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK), equipped with a 300 mm lens possessing a focal length of the 150 mm, and an Air Purge System (not greater than 14.5 psi). The system is controlled with a computer and software accompanying the instrument, such as the Spraytec software version 3.20 or equivalent, utilizing Mie Theory and Fraunhofer Approximation optical theory. The system is placed in a fume hood for atmospheric control with care taken to place it directly opposite the actuation spray plume trajectory to prevent saturation, with an air flow rate of between 50-70 L/min (60 L/min was the target rate). The distance from the dispensing nozzle orifice to the laser during measurements is 30 cm. A new spray bottle is used for each sample replicate analyzed. Lighting conditions are not changed during or between the background control and test sample data collection periods. Light obscuration values below 95% are considered suitable to provide accurate results.

Samples analyzed included “example” samples, which are samples according to this disclosure, and comparative samples. All newly created example samples are tested within three hours of preparation and are measured at temperatures between 20-22° C. Deionized water is used as a standard reference spray and is labeled as the “control.”

Spray measurements are conducted using the following spray SOP instrument configuration: Rapid SOP type is chosen, and the following settings are selected: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

Spray measurements are conducted using the following Spray Procedure: The sample is first test sprayed from the spray bottle for 1-2 seconds, to ensure that the nozzle is free flowing and not clogged; the sample is loaded into the holding device in the front of the Spraytec 2000 system. The actuator is fully depressed. The spray droplet size data are viewed and saved as “Average Scatter Data”.

a. The value obtained from each sample measurement is normalized to the control sample value in accordance with the following calculations:
The value of Spray D(50) Normalized=D(50)_{Example}/D(50)_{Control};
The value of Spray D(90) Normalized=D(90)_{Example}/D(90)_{Control};
The value of Spray D(3,2) Normalized=D(3,2)_{Example}/D(3,2)_{Control};
   wherein:

Spray D(50), Spray D(90), and Spray D(3,2) are values obtained from the instrument software for both the example samples and control samples separately.

Each of the Spray D(90) Normalized and Spray D(3,2) Normalized values reported for each of the samples is the average value calculated from five replicate spray plumes per sample.

### Determination of the Hunter L.a.b. (CIE) b* Value

The formation of yellow color is measured using the Hunter L.a.b. (CIE) method. The b* value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.”

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity Method

A turbidimeter is used to measure the turbidity of the compositions. This instrument measures the turbidity of liquids in Nephelometric Turbidity Units (NTU). The method of measuring turbidity is described in detail in the following reference: Hach 2100Q and 2100Q is User Manual, Edition 6, August 2021, from the Hach Company. If a sample is not homogenous prior to analysis, the sample is inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Surface Tension Method

Surface tension is measured according to ASTM 1331-14 (Published January 2015) using an EZ-Pi tensiometer (Kibron, Parrish, Fla.), or equivalent. The instrument is calibrated according to the manufacturer instructions using DI water. Measurements are taken and values are reported in mN/m.

### Temperature Stability

Samples are prepared by combining all ingredients in a 4-ounce glass vial at ambient conditions (25 deg. C). The sample is mixed and, five minutes after mixing is completed, the sample is observed for initial stability.

Cold temperature cycle stability is measured by filling a 4-ounce glass vial with a sample composition. The vial is sealed and stored at 5° C. for 12 to 14 hours. The vial is then moved to a 25° C. environment and stored for 10 to 12 hours, thereby completing one cold temperature cycle. This is repeated two more times, for a total of three cold temperature cycles. After the final incubation at 25° C., the vials are visually observed for stability (and may be assessed for turbidity and b* value using the Turbidity and Hunter L.a.b. (CIE) method described above).

### Weed Control Efficacy Test Method

Plant samples are prepared by growing plants from seed in an indoor hydroponic setting. Hydroponic systems are built the using materials in Table 10, or equivalents. The hydroponic system includes six shelves of 2′×4′ flood trays (with an additional shelf on top for LED light attachment) that are spaced apart vertically by 10″. Each flood tray is lighted with two full-spectrum LED grow lights, and the flood trays are connected via polyethylene tubing so that water may continually flow from the uppermost flood tray through the five below and back into the reservoir underneath. Hydroponic systems are contained within an indoor greenhouse (FlowerHouse, 10′×10′), artificial light is maintained on a 12:12 light:dark cycle, temperature is maintained at 30±3° C., relative humidity (RH) is maintained at 70±10%, and dissolved nutrients are controlled at an electrical conductivity (EC) of 1,000±300 micro-Siemens (S). As an example, Broadleaf plantain (Plantago major) plants are grown from seed (Strictly Medicinal Seeds, Williams, or equivalent) in rockwool hydroponic medium (Grodan A-OK Starter Plugs (2″×2″, 50 V-shaped plugs arranged in a 5×10 flat or the like) held within 1020 mesh planting trays (Johnny's Selected Seeds). Seeding is completed by placing approximately 500 P. major seeds into a precision vacuum seeder (50 small, countersunk holes, size F, Johnny's Selected Seeds) to equidistantly plant 50 seeds onto the water-soaked plug sheet (one seed at the center of each of the 2″×2″ rockwool Grodan plugs within the sheet). The flat of seeded rockwool plants is then placed into a flood table (Active Aqua) within the hydroponic growth system, which supplies controlled lighting, water, and nutrients. Plants are grown to a desired size from the 3-4 leaf stage, or larger, depending on the objectives of the experiment. Variations could occur if different plant species are grown.

Water is provided to the plants by pumping the water from the reservoir to the top flood tray, filling down to each of the subsequent trays below, eventually flowing back into the reservoir. Flood trays are tailored to completely drain via siphoning and may need adjustment to assure that flats of plants are not constantly sitting in water. Nutrients (MasterBlend 4-18-38 Master Kit) are provided as a liquid to plants through addition to water in the hydroponic system reservoir. Liquid nutrients are separated into two separate 10× concentrated mixes. Mix A contains 120 g MgSO4 and 240 g 4-18-38 NPK (Nitrogen-Phosphorus-Potassium) dissolved in 1 L of DI H2O, and Mix B contains 240 g of Ca(NO3)2 dissolved in 1 L of DI H2O. Nutrient Mixes A and B are added to the hydroponic system reservoir in a 1:1 ratio to maintain an EC of 1,000±300 S. Plants are watered weekly until removal, and newly seeded flats are added to the system after watering to avoid seed displacement. No plants are added back into the system following treatment to ensure no outside chemical contamination.

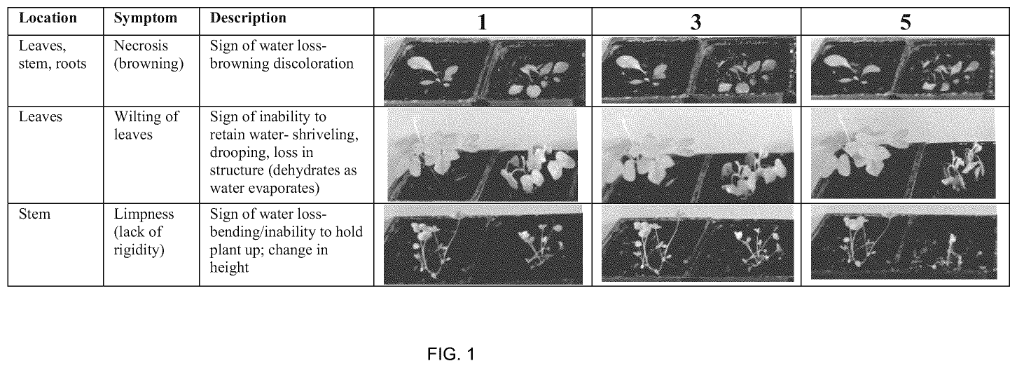

Plants are removed from the greenhouse prior to testing when a desired size is achieved. Two to ten replicates of healthy plants are used per treatment and are selected to represent a comparable size within each treatment, and across treatments. One set of plants is kept as an untreated control (UTC). Test plants are sprayed with the sample composition until visually wet (approximately 3 to 10 sprays depending on plant size). A timer is then set, and the treated plant and an untreated control plant is placed in a portable tent enclosure. The plants are kept under artificial light at 25±5° C. and 50%±5% RH for the observation period. After 1 hour, 3 hours, and 24 hours, the treated plants and control plants are visually assessed for leaf color, leaf wilting, and stem wilting. A rating score of 0-5 is used for each attribute relative to the untreated control, where “0” indicates no difference versus control and “5” indicates the greatest difference versus control. FIG. 1 shows a Symptom Assessment for ratings 1, 3, and 5, where the images on the left show an untreated control and images on the right show a treated sample. The total rating for each attribute is added together for a total max score of 15. The average of replicates per treatment is reported.

TABLE 10
Hydroponic System Construction Materials.

| Equipment | Manufacturer | Amount | Specifications |
|---|---|---|---|
| Chrome wire shelving unit | ULINE | 1 | 2 × 4 × 6′ |
| Additional chrome wire shelves | ULINE | 1 × 2 pk | 2 × 4′ |
| Polyurethane shelving unit casters | ULINE | 1 × 4 pk | 4″ |
| 40 Gallon water reservoir | Active Aqua | 1 | 38.5″ × 33.5″ × 13.25″ |
| Bulkhead fittings for drainage | Botanicare | 6 | ¾″ |
| Water pump | Danner | 1 | 1200GPH |
| Full spectrum LED grow lights | Barrina | 2 × 6 pk | 6′, 42 W |
| Barbed Elbow Fittings | DI Wholesale | 18 | |
| Hose Clamps | Breeze | 2 | ¾″ |
| Polythylene tubing | Netafilm USA | 25′ | ¾″ |
| Flood tables | Active Aqua | 6 | 2′ × 4′ |
| Mesh Planting Trays | Johnny's Seeds | 24 | 1020 |
| Rockwool starter plugs | Grodan | 24 | 2″ × 2″ plugs in 1020 sheet |
| Countersunk vacuum seeder plate | Johnny's Seeds | 1 | Small, Countersunk, Size F, 1020 |

### Combinations

Paragraph 1. A pest control composition comprising:
a. from about 1% to about 12.5%, preferably from about 1% to about 8%, by weight of the pest control composition of sodium lauryl sulfate;
b. from about 0.15% to about 15%, preferably about 0.5% to about 10%, by weight of the pest control composition of an active ingredient;
c. from about 0.5% to about 10%, preferably from about 1% to about 6%, by weight of the pest control composition of urea; and
d. from about 60% to about 95% by weight of the pest control composition of water.
   Paragraph 2. A process for making a pest control composition, wherein the composition comprises sodium lauryl sulfate, an active ingredient, an optional solvent, and urea, the process comprising the steps of:
a. combining the sodium lauryl sulfate, the active ingredient, and the optional solvent, to make an active ingredient premix;
b. combining the active ingredient premix with an aqueous phase comprising water, urea, and an optional ingredient selected from a pH adjusting agent, a preservative, or a mixture thereof to form the pest control composition;
wherein the pest control composition has a pH of about 3.0 to about 11.0.
   Paragraph 3. The pest control composition or process for making a pest control composition according to Paragraphs 1 or 2, wherein the active ingredient comprises geraniol.
   Paragraph 4. The pest control composition or process for making a pest control composition according to any one of Paragraphs 1-3, wherein the pest control composition comprises from about 0.1% to about 45% by weight of the composition of a solvent selected from the group consisting of isopropyl alcohol, triethyl citrate, isopropyl myristate, propylene carbonate, ethyl lactate, butyl lactate, butyl stearate, glycerin, and mixtures thereof, preferably a solvent selected from the group consisting of isopropyl alcohol, triethyl citrate, and mixtures thereof.
   Paragraph 5. The pest control composition or process for making a pest control composition according to any one of Paragraphs 1-4, wherein the pest control composition comprises less than about 3% by weight of the composition of isopropyl alcohol.
   Paragraph 6. The pest control composition or process for making a pest control composition according to any one of Paragraphs 1-5, wherein the pest control composition comprises from about 0.5% to 10%, preferably about 1% to about 7%, by weight of the composition of triethyl citrate.
   Paragraph 7. The pest control composition or process for making a pest control composition according to any one of Paragraphs 1-6, wherein the weight ratio of active ingredient to sodium lauryl sulfate is about 1:3 to about 1:1.
   Paragraph 8. The pest control composition or process for making a pest control composition according to any one Paragraphs 1-7, wherein the active ingredient further comprises corn mint oil, peppermint oil, spearmint oil, rosemary oil, thyme oil, citronella oil, clove oil, cinnamon oil, cedarwood oil, garlic oil, geranium oil, lemongrass oil, eugenol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably corn mint oil, peppermint oil, spearmint oil, rosemary oil, lemongrass oil, citronella oil, or mixtures thereof.
   Paragraph 9. The pest control composition or process for making a pest control composition according to any one of Paragraphs 1-8, wherein the pest control composition comprises from about 0.5% to about 10%, preferably from about 1% to about 8%, by weight of the composition of geraniol.
   Paragraph 10. The pest control composition or process for making a pest control composition according to any one of Paragraphs 1-9, wherein the pest control composition comprises from about 0.15% to about 10%, preferably about 0.50% to about 10%, by weight of the composition of corn mint oil, peppermint oil, spearmint oil, rosemary oil, thyme oil, citronella oil, clove oil, cinnamon oil, cedarwood oil, garlic oil, geranium oil, lemongrass oil, eugenol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably corn mint oil, peppermint oil, spearmint oil, rosemary oil, lemongrass oil, citronella oil, or mixtures thereof.
   Paragraph 11. The pest control composition or process for making a pest control composition according to any one of Paragraphs 1-10, wherein the pest control composition further comprises a pH adjusting agent selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof.
   Paragraph 12. The pest control composition or process for making a pest control composition according to any one of Paragraphs 1-11, wherein the pest control composition comprises about 3% volatile organic compounds (VOCs) by weight or less.
   Paragraph 13. The pest control composition or process for making a pest control composition according to any one of Paragraphs 1-11, wherein the pest control composition comprises from about 3% to about 35% by weight of volatile organic compound (VOC).
   Paragraph 14. The pest control composition or process for making a pest control composition according to any one of Paragraphs 1-13, wherein the pest control composition has a pH of about 3.0 to about 11.0, preferably about 5.0 to about 8.0, more preferably about 6.0 to about 7.0.
   Paragraph 15. The pest control composition or process for making a pest control composition according to any one of Paragraphs 1-14, wherein the pest control composition has a turbidity less than about 20 NTU and greater than about 0 NTU, preferably less than about 10 NTU and greater than about 0 NTU.
   Paragraph 16. The pest control composition or process for making a pest control composition according to any one of Paragraphs 1-15, wherein the pest control composition is substantially free of synthetic pesticides, mineral oil, colorants, or a combination thereof.
   Paragraph 17. The pest control composition or process for making a pest control composition according to any one of Paragraphs 1-16, wherein the pest control composition is packaged in a transparent or translucent container.
   Paragraph 18. The pest control composition or process for making a pest control composition according to any one of Paragraphs 1-17, wherein one or more of the ingredients are food use safe, preferably all the ingredients are food use safe.
   Paragraph 19. The pest control composition or process for making a pest control composition according to any one of Paragraphs 1-18, wherein the pest control composition is a spray composition.
   Paragraph 20. The pest control composition or process for making a pest control composition according to any one of Paragraphs 1-19, wherein the pest control composition has a b* value of about 0 to about 5.
   Paragraph 21. The pest control composition or process for making a pest control composition according to any one of Paragraphs 1-20, wherein the pest control composition is an oil-in-water emulsion or a micellar dispersion.
   Paragraph 22. The pest control composition or process for making a pest control composition according to any one of Paragraphs 1-21, wherein the pest control composition has a viscosity ranging from about 1 cps to about 300 cps.
   Paragraph 23. A method of controlling a pest comprising the steps of: (i) providing a pest control composition according to any one of Paragraphs 1-22; (ii) contacting the pest with the pest control composition; (iii) optionally wiping any excess pest control composition from an adjacent surface(s).
   Paragraph 24. A method of controlling one or more weeds in a vegetable garden comprising the steps of: (i) providing a pest control composition according to any one of Paragraphs 1-23; (ii) contacting the one or more weeds with the pest control composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pest control composition comprising:
a. from about 1% to about 12.5% by weight of the pest control composition of sodium lauryl sulfate;
b. from about 0.15% to about 15% by weight of the pest control composition of an active ingredient;
c. from about 0.5% to about 10% by weight of the pest control composition of urea; and
d. from about 60% to about 95% by weight of the pest control composition of water.

2. The pest control composition of claim 1, wherein the active ingredient comprises geraniol.

3. The pest control composition of claim 1, wherein the pest control composition comprises from about 0.1% to about 45% by weight of the composition of a solvent selected from the group consisting of isopropyl alcohol, triethyl citrate, isopropyl myristate, propylene carbonate, ethyl lactate, butyl lactate, butyl stearate, glycerin, and mixtures thereof.

4. The pest control composition of claim 1, wherein the pest control composition comprises from about 0.01% to about 3% by weight of the composition of isopropyl alcohol.

5. The pest control composition of claim 4, wherein the pest control composition further comprises from about 0.5% to about 10% by weight of the composition of triethyl citrate.

6. The pest control composition of claim 1, wherein the weight ratio of active ingredient to sodium lauryl sulfate is about 1:3 to about 1:1.

7. The pest control composition of claim 2, wherein the active ingredient further comprises corn mint oil, peppermint oil, spearmint oil, rosemary oil, thyme oil, citronella oil, clove oil, cinnamon oil, cedarwood oil, garlic oil, geranium oil, lemongrass oil, eugenol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof.

8. The pest control composition of claim 1, wherein the pest control composition comprises from about 0.5% to about 10% by weight of the composition of geraniol.

9. The pest control composition of claim 1, wherein the pest control composition further comprises a pH adjusting agent selected from the group consisting of citric acid or a salt thereof, malic acid or a salt thereof, acetic acid or a salt thereof, fumaric acid or a salt thereof, humic acid or a salt thereof, and mixtures thereof.

10. A pest control composition comprising:
a. from about 1% to about 12.5% by weight of the pest control composition of sodium lauryl sulfate;
b. 0.5% to about 10% by weight of the pest control composition of a first active ingredient, wherein the first active ingredient is geraniol;
c. from about 0.5% to about 10% by weight of the pest control composition of urea;
d. from about 0.5% to about 10% by weight of the pest control composition of triethyl citrate; and
e. from about 60% to about 95% by weight of the pest control composition of water;
wherein the composition comprises about 3% volatile organic compounds (VOCs) by weight or less.

11. The pest control composition of claim 10, wherein the pest control composition has a pH of about 3.0 to about 11.0.

12. The pest control composition of claim 10, wherein the pest control composition further comprises from about 0.15% to about 10% by weight of the composition of a second active ingredient selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, eugenol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof.

13. The pest control composition of claim 10, wherein the pest control composition is substantially free of synthetic pesticides, mineral oil, colorants, or a combination thereof.

14. The pest control composition of claim 10, wherein one or more of the ingredients are food use safe.

15. The pest control composition of claim 10, wherein the pest control composition is a spray composition.

16. The pest control composition of claim 10, wherein the pest control composition is an oil-in-water emulsion or a micellar dispersion.

17. A method of controlling one or more weeds comprising the steps of:
(i) providing a pest control composition, wherein the pest control composition comprises:
a. from about 1% to about 12.5% by weight of the pest control composition of sodium lauryl sulfate;
b. from about 0.15% to about 15% by weight of the pest control composition of an active ingredient;
c. from about 0.5% to about 10% by weight of the pest control composition of urea;
d. from about 60% to about 95% by weight of the pest control composition of water;
(ii) contacting the one or more weeds with the pest control composition.

18. The method of claim 17 wherein the weight ratio of active ingredient to sodium lauryl sulfate is about 1:3 to about 1:1.

19. The method of claim 18 wherein the pest control composition comprises from about 0.01% to about 3% by weight of the pest control composition of isopropyl alcohol.

20. The method of claim 17, wherein the contacting step comprises dispensing the pest control composition from a spray dispenser, and wherein the composition exhibits a Spray D(90) of from about 100 microns to 900 microns when dispensed through the spray dispenser.
